(19) United States
(12) Patent Application Publication
(10) Pub. No.: US 2022/0413181 A1
(43) Pub. Date: Dec. 29, 2022

(54) COUPLED PLUVIAL, FLUVIAL, AND URBAN FLOOD TOOL

(71) Applicant: One Concern, Inc., Menlo Park, CA (US)

(72) Inventors: Ahmad Wani, Mountain View, CA (US); Nicole Hu, Mountain View, CA (US); Feyera Hirpa, Menlo Park, CA (US); Wang Zhan, Menlo Park, CA (US); Shabaz Patel, Menlo Park, CA (US); Samuel Lamont, Menlo Park, CA (US); Yi Liu, Menlo Park, CA (US); Zhuo Liu, Menlo Park, CA (US); Ting Li, Menlo Park, CA (US); Yu Zhang, Menlo Park, CA (US)

(21) Appl. No.: 17/362,501

(22) Filed: Jun. 29, 2021

(51) Int. Cl. G01V 99/00; G06F 30/28; G06F 30/12; G08B 21/18

(52) U.S. Cl. CPC G01V 99/005; G06F 30/28; G06F 30/12; G08B 21/182; G06F 2113/08

(57) ABSTRACT

Methods, systems, and computer programs are presented for determining flood levels within a region. One method includes an operation for detecting an alert generated by one of a riverine, a coastal, or an urban model. Further, the method includes operations for selecting one or more regions for estimating flood data based on the detected alert, and for calculating, by an inundation model, region flood data for each of the selected regions based on outputs from the riverine model, the coastal model, and the urban model. Additionally, the method includes an operation for combining the region flood data for the selected one or more regions to obtain combined flood data. The combined flood data is presented on a user interface, such as on a flood inundation map.

### TECHNICAL FIELD

The subject matter disclosed herein generally relates to methods, systems, and machine-readable storage media for predicting flood levels in a geographical region.

### BACKGROUND

Predicting floods is important because of the negative economic impact that floods may cause to businesses, residents, and government institutions. However, predicting floods is a complex problem that depends on many parameters, such as a weather forecast, river flows, topology, building construction, and so forth. Consequently, flooding prediction programs tend to use large amounts of resources, especially if predictions need to be made for large geographic areas.

### BRIEF DESCRIPTION OF THE DRAWINGS

Various of the appended drawings merely illustrate example embodiments of the present disclosure and cannot be considered as limiting its scope.

FIG. 1 is a summary workflow for predicting flooding by combining coastal, riverine, and urban modeling, according to some example embodiments.

FIG. 2 illustrates how to combine the coastal, riverine, and urban models, according to some example embodiments.

FIG. 3 illustrates the inundation modeling by regions, according to some example embodiments.

FIG. 4 shows the output of the riverine model used as input for the inundation model, according to some example embodiments.

FIG. 5 illustrates the use of synthetic information for modeling water flows, according to some example embodiments.

FIG. 6 shows the initial selection of points for determining the riverine information, according to some example embodiments.

FIG. 7 illustrates the operation for fine-tuning the points associated with the river channels, according to some example embodiments.

FIG. 8 illustrates how to use the output of the riverine model as input for the inundation model, according to some example embodiments.

FIG. 9 shows a high-level flow of operations for estimating the flood information, according to some example embodiments.

FIG. 10 is a map illustrating a maritime mesh for the coastal model, according to some example embodiments.

FIG. 11 is an example of a model mesh with a transition from high to low resolution, according to some example embodiments.

FIG. 12 is a sample architecture for calculating flood parameters, according to some example embodiments.

FIG. 13 is a sample sequence diagram for calculating flood parameters, according to some example embodiments.

FIG. 14 illustrates how the data from multiple workers is combined, according to some example embodiments.

FIG. 15 shows components of a worker program, according to some simple embodiments.

FIG. 16 is a user interface (UI) for showing flooding in a region, according to some example embodiments.

FIG. 17 is a flowchart of a method for determining flood levels within a region, according to some example embodiments, for performing damage simulations.

FIG. 18 is a block diagram illustrating an example of a machine upon or by which one or more example process embodiments described herein may be implemented or controlled.

### DETAILED DESCRIPTION

Example methods, systems, and computer programs are directed to determining flood levels within a region. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Multiple models may be used to determine flood levels within a region. A coastal storm surge model, also referred to as simply a coastal model, uses weather forecasts to predict coastal water levels, which are used to issue flood alerts on a coastal region. A riverine model predicts the streamflow and water level in rivers, which is used to issue flood alerts in areas near the rivers. An urban model is used to predict runoff from extreme rainfall in urban areas. The urban model uses runoff and infiltration rate to issue flood alerts in urban areas.

Since coastal areas, rivers, and cities overlap in some places, the three models are combined to generate accurate flood predictions over large geographic areas (e.g., a whole country) to take into consideration the data provided by each of the three models.

In one aspect, a scalable, automated method is presented for coupling riverine and inundation models. The model ensures that water source points are within river channels by using modeling with synthetic data. Further, the methods are operable on a large scale by modeling for a plurality of regions to cover a large area (e.g., a country), where the regions have the same outside boundary (e.g., the whole country) but modeling mesh resolution is higher within the region than outside the region.

One general aspect includes a method that includes an operation for detecting an alert generated by one of a riverine, a coastal, or an urban model. Further, the method includes operations for selecting one or more regions for estimating flood data based on the detected alert, and for calculating, by an inundation model, region flood data for each of the selected regions based on outputs from the riverine model, the coastal model, and the urban model. Additionally, the method includes an operation for combining the region flood data for the selected one or more regions to obtain combined flood data. The combined flood data is presented on a UI, such as on a flood inundation map.

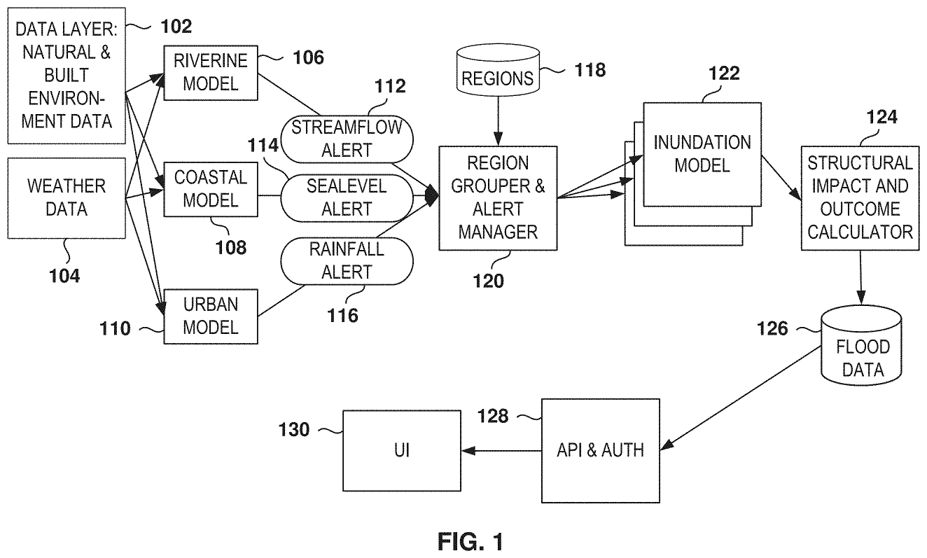

FIG. 1 is a summary workflow for predicting flooding by combining coastal, riverine, and urban modeling, according to some example embodiments. Different types of data may be utilized for the riverine model 106, the coastal model 108, and the urban model 110. In the illustrated example, the data includes natural and built-environment data 102 and weather data 104, but other environments may utilize additional data.

The data is prepared and structured so it can be used by the different models. After making estimates of flooding, each of the models may generate an alert indicating possible flooding in the area: the riverine model 106 generating streamflow alerts 112, the coastal model 108 generating sea level alerts 114, and the urban model 110 generating rainfall alerts 116. The streamflow alert 112 is generated when a river level is expected to go over the flood level. The sea level alert 114 is generated when the sea level in coastal areas is predicted to be above a predetermined threshold. Further, the rainfall alert 116 predicts flooding in urban areas caused by rainfall.

The alerts trigger activation of the region grouper and alert manager 120, which uses topographical data for the regions stored in regions database 118 to determine which inundation model to run, for which region, and for which period.

In some example embodiments, any alert will trigger the region grouper and alert manager 120, which means that the region grouper and alert manager 120 is not invoked until one alert is triggered.

A coastal and inundation model 122 determines the flood levels in the identified regions. At operation 124, a calculation is made of the structural impact (e.g., building damage) of the flood. The results are stored in a flood-data database 126.

In some example embodiments, an Application Programming Interface (API) 128 is provided to access the flood data. e.g., using an API call to obtain the water levels in a predetermined area for a forecasted time. The API provides authentication methods for validating access and may provide multiple levels of access to the data. Further, a UI 130 is used to visualize the data (which can be obtained via the API), e.g., by presenting a flood map.

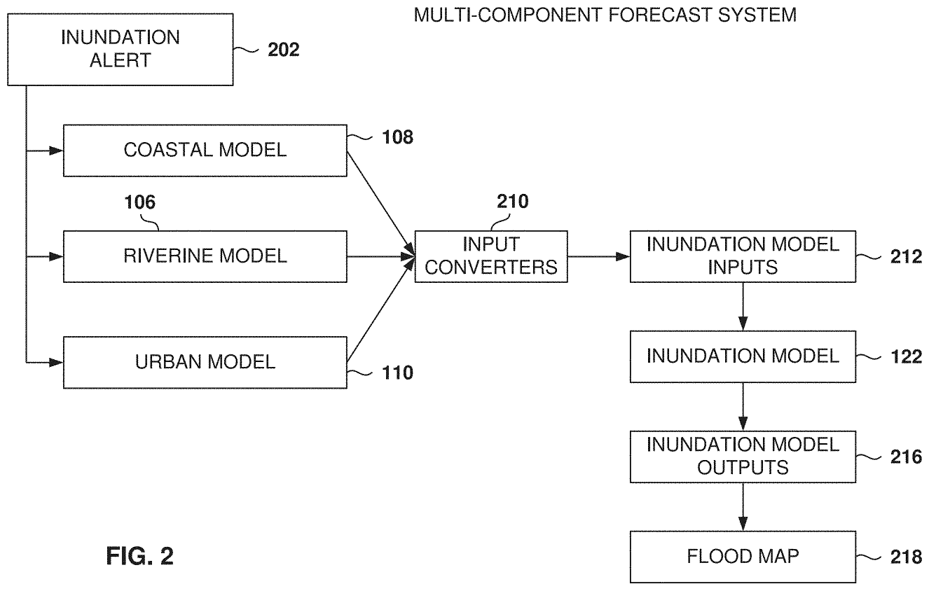

FIG. 2 illustrates how to combine the coastal, riverine, and urban models, according to some example embodiments. After an inundation alert 202 is triggered (e.g., one or more of the streamflow alerts 112, sea level alerts 114, and rainfall alerts 116), the different models are invoked (if necessary) to generate the respective prediction.

The outputs of the models are converted to a standard, homogenous format by the input converters 210 (convert to a valid input format for the inundation model). In general, the different models use different ways to store the data (e.g., different data structures), so the conversion is made to be able to use the information in a uniform way for the inundation model 122.

The result from the data conversions are the inundation-model inputs 212, which are inputted to the inundation model 122. For example, the coastal model 108 provides the coastal water levels, the riverine model 106 provides the stream flow along the riverbeds, and the urban model 110 provides the rainfall infiltration levels.

The inundation model 122 generates the inundation model outputs 216 (e.g., prediction of water levels for each section of the map). The results are presented in a flood map 218 (e.g., in the UI 130 of FIG. 1). This is a unified map showing the information generated by the combination of the models.

Because the models are alert driven, the software does not have to be constantly running expensive simulations. Also, by having separate models and selecting the regions of interest, it is possible to have almost real-time flood predictions.

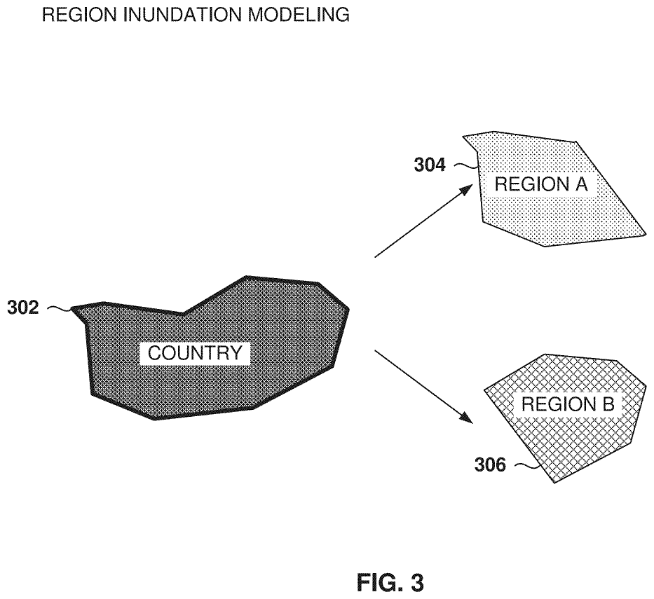

FIG. 3 illustrates the inundation modeling by regions, according to some example embodiments. Running an inundation model for a large geographical region, such as country 302 (e.g., Japan, US), requires large amounts of computer resources, although flooding may occur in just one city or a few cities.

An approach to deploying a hydrodynamic inundation model for a large region includes breaking the large region into smaller regions for independent modeling. The geographical region is modeled using a mesh of connected polygons (e.g., triangles, hexagons) and the size of the polygons may vary, e.g., in the range from 5 m to one or more kilometers. The polygons in the mesh are referred to herein as cells. The higher the resolution (the smaller the size of the cells), the more computing resources that are required to predict the flooding.

Embodiments are presented with reference to a country, but the same principles may be used for large geographic areas within a country or even for multiple countries. In some example embodiments, the country 302 is divided into two regions: region A 304 and region B 306. Other embodiments may use a different number of regions, e.g., in the range from 2 to 50.

In some example embodiments, a SCHISM (Semi-implicit Cross-scale Hydroscience Integrated System Model) modeling system is utilized, but other modeling may be used using the same principles of using meshes of varying resolutions. SCHISM is an open-source community-supported modeling system based on unstructured grids, designed for seamless simulation of three-dimensional (3D) baroclinic circulation across creek-lake-river-estuary-shelf-ocean scales. SCHISM uses an efficient and accurate semi-implicit finite-element/finite-volume method with Eulerian-Lagrangian algorithm to solve the Navier-Stokes equations (in hydrostatic form) in order to address a wide range of physical and biological processes.

After the regions are defined, the modeling domains are determined (where the inundation model runs). In the illustrated example, there are two modeling domains.

Within each modeling domain, unstructured model meshes are created (e.g., triangles or quadrilaterals). In some example embodiments, the SMS tool from Aquaveo is used, but other tools may also be used.

Using the region approach, the modeling cost can further be reduced by using the alert driven approach, as discussed above with reference to FIG. 1. Only when a flood alert is detected in a region (e.g., predicted coastal storm surge is higher than water level threshold; predicted riverine streamflow is higher than warning discharge value; predicted urban rainfall is heavier than flood rainfall threshold), the inundation model for that modeling domain is executed. Thus, it may be possible to calculate flood inundation estimates for a region of interest in less than an a hour (or even a few minutes, depending on the amount of computing resources available) instead of having to wait a whole day to calculate the model for the whole country. Thus, embodiments provide a way to calculate flood estimates virtually in real time.

Thus, there are cost-saving factors: not having to run the model at high-resolution for the entire country and only running the model for areas where flood alerts have been triggered.

The approach can be used for a larger number of regions (e.g., 3 to 100) to develop any large-scale inundation modeling, such as for the whole United States. China, or Europe. As long as cities and regions of interest are clearly defined, the cities can be grouped based on their shapefiles, geographic distributions, and maximum supportable area in high-resolution (considering computing cost and latency).

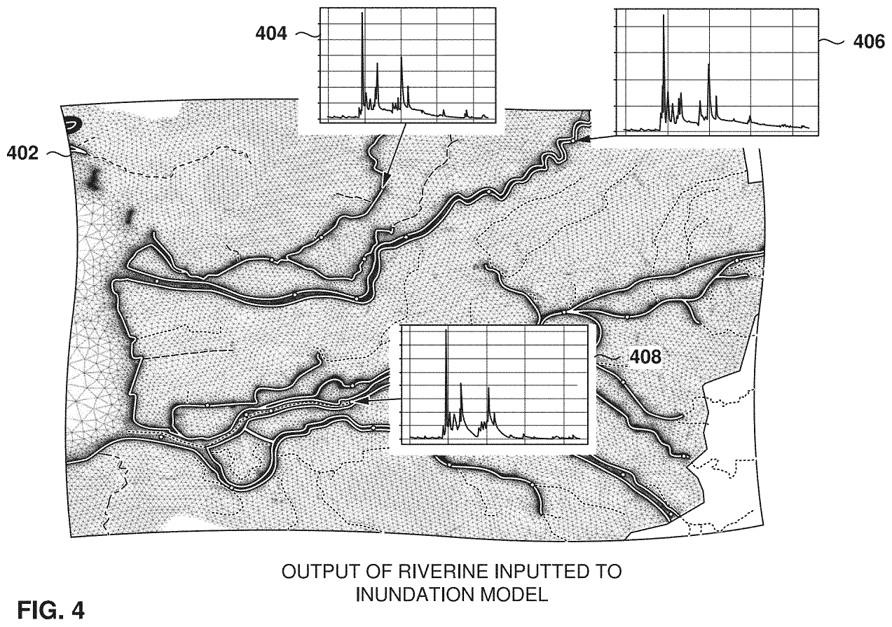

FIG. 4 shows the output of the riverine model used as input for the inundation model, according to some example embodiments. Map 402 is an example of a mesh with different resolutions. In this example, the cells in the mesh are triangles, and the map 402 includes several rivers that run into a coastal area on the left.

Triangles on most of the map 402 have a higher resolution (e.g., small triangles) than the triangles on the left side, which have a lower resolution (bigger triangles). As can be observed in the transition area, moving left, the resolution is gradually changed from high to low resolution.

In some example embodiments, the riverine model is used as input for the inundation model, making sure that the points within the rivers define a channel for the inundation model. The process is automated and is highly scalable to large regions.

In some example embodiments, the riverine model generates a time series of values for time and water flow in each cell of the mesh for the river channels. This time series is injected into the inundation model at specific points throughout the mesh. The inundation model then uses those values to generate flood estimates.

One of the challenges is to make sure that the points, injected from the riverine data into the inundation model, are actually in a river channel. Otherwise, if points outside the river channel are identified as being in the river channel, the process would inject water onto the landscape for these points, causing flooding nearby, instead of the water flowing down the river.

Charts 404, 406, and 408 show three time series injected in the inundation model for three points on the river channels. The horizontal axis is time and the vertical axis is the amount of water flowing through the point (e.g., cubic meters per second).

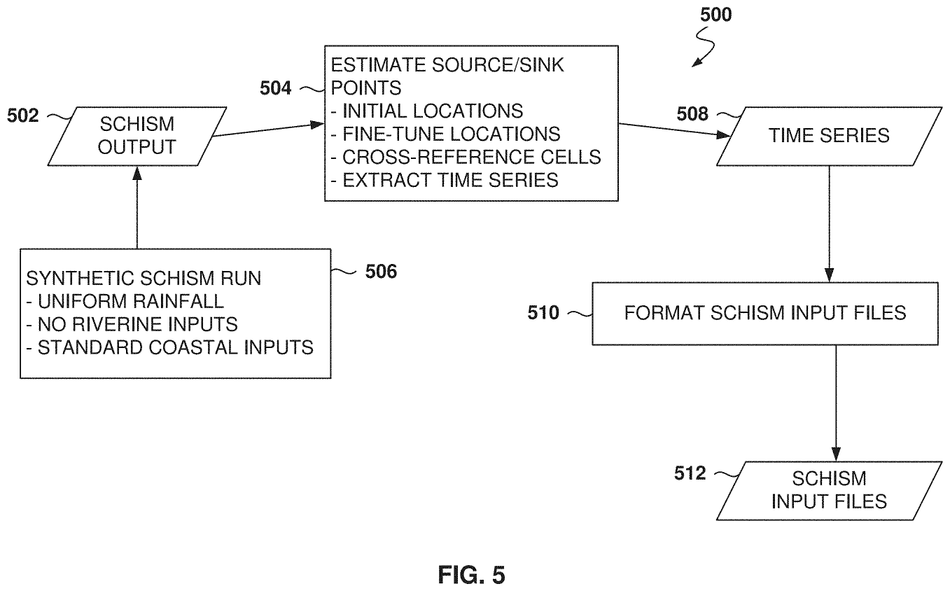

FIG. 5 illustrates the use of synthetic information for modeling water flows, according to some example embodiments. The method 500 is for coupling the riverine model to the inundation model, through the use of source and sink points, to determine the volume of water injected to the inundation model. A source point is a point that passes a flow of water from the riverine to the inundation model, and a sink point is a point that will keep received water to a certain volume, with the sink point being a point at the downstream of end of the model boundary or in a topographical area with no natural outflow.

In some example embodiments, the riverine model is a LISFLOOD model and the inundation model is SCHISM. However, other models may be used, such as MOI. The inclusion of the urban model is described separately.

At operation 506, a synthetic SCHISM model is run to determine source and sink point locations. It is referred to as a synthetic model because the data is created artificially to add water into the area being modeled. The model is run to determine how the water flows in the area. The synthetic SCHISM simulation is performed to ensure that the estimated locations of source and sink points are within the river channels as represented by the inundation model.

In some example embodiments, the synthetic data includes assuming uniform rainfall across the region, suppression of riverine water flows, and standard coastal water-level data. The result is SCHISM output 502 with the information about the source and sink points.

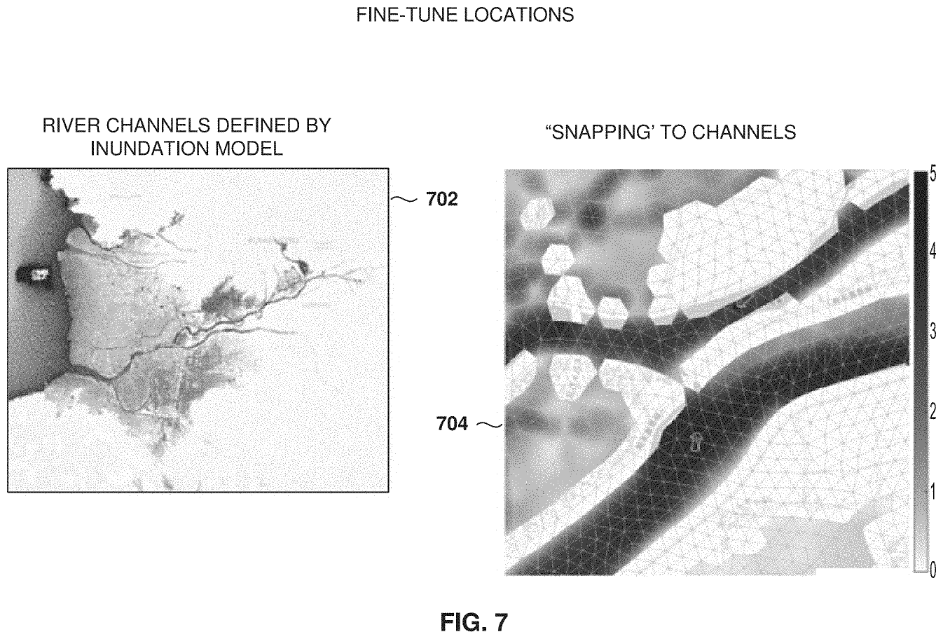

At operation 504, a script is executed to automatically estimate source and sink point locations throughout the stream network and fine-tune these locations using the synthetic SCHISM output 502. Further, a LISFLOOD discharge time series 508 corresponding to the appropriate SCHISM cell is extracted and formatted. Further yet, the SCHISM riverine-inputs converter takes this output and writes the necessary SCHISM input files to support a SCHISM simulation. The SCHISM output 502 includes the maximum depth at the point over the entire simulation time. Map 702 in FIG. 7 is one example of the representation of the SCHISM output 502.

The fine-tuning operation is performed because the inundation model mesh may not match exactly with the digital elevation model (DEM), which is data defining the elevation on each of the cells. In many cases, the inundation model does not accurately represent the terrain and the elevation of the cells, and there may be a mismatch with the river channel. By running the synthetic model, it is possible to fine tune the locations of the rivers by selecting river channels with cells having the bigger depth.

The initial source and sink locations are spaced out at a user-defined interval, along a 30 m stream network, with an upstream limit defined by minimum drainage area. Additionally, sources are located at the most upstream points along rivers flowing into urban areas since these are areas of high-resolution inundation modeling and are of most interest for the user.

In some example embodiments, operation 504 includes several file dependencies. High-resolution (30 m) raster stream lines with stream IDs (Kyushu_stream_id_fr.nc), high-resolution raster upstream drainage area (flow accumulation) (yamadai_upa_30m.tif), vector polygon defining the domain boundary (kyushu_boundary_4326.geojson), and urban area polygons, which get converted to 1 km resolution grids to align with the output of LISFLOOD.

Further, the parameters used include: desired spacing between source points along the river network (m) (e.g., initial value of 5000) (PT_DIST) and minimum upstream drainage area for source points (e.g., initial value of 3.5 km²) (SRC_UPA_THRESH). The result is a vector point file of initial source locations snapped to high-resolution raster streamlines.

Fine-tuning the source and sink locations includes ensuring that the river points are within the river channel as represented by the inundation model. The file dependencies include the initial source point locations and the SCHISM output 502 for the synthetic SCHISM run. Additional configurable parameters include the maximum search radius for the nearest-neighbor search (e.g., initial value 100 m), and the number of neighbors to include in the nearest-neighbor search (e.g., initial value of 10).

The output is a vector point file of final source locations snapped and mapped to inundation model mesh cells.

At operation 510, the SCHISM input files are formatted according to SCHISM requirements to generate the SCHISM input files 512. The source and sink locations, determined by the high-resolution inundation model, are mapped to the appropriate grid cells of the low resolution riverine model output, which enables extraction of the riverine time series for use as sources (or potentially sinks) to the inundation model.

The file dependencies include the final source/sink points from operation 504, the low resolution (e.g., 1 km) stream ID raster (streamid.nc), the low resolution flow accumulation raster (accuflux.nc), and the LISFLOOD time series output file (dis.nc). The output is the SCHISM input files 512 that include the final source point locations attributed with corresponding LISFLOOD grid cell x-y values and a formatted time series file of the LISFLOOD output at each source point location.

Further, a riverine inputs converter creates the necessary input files to run the inundation model. The file dependencies include the formatted time series. The parameters for the conversion include the desired SCHISM model start time (schism_start_time_utc) and the number of hours of the SCHISM run time (SCHISM_duration). The outputs are the source and sink points for the SCHISM model simulation.

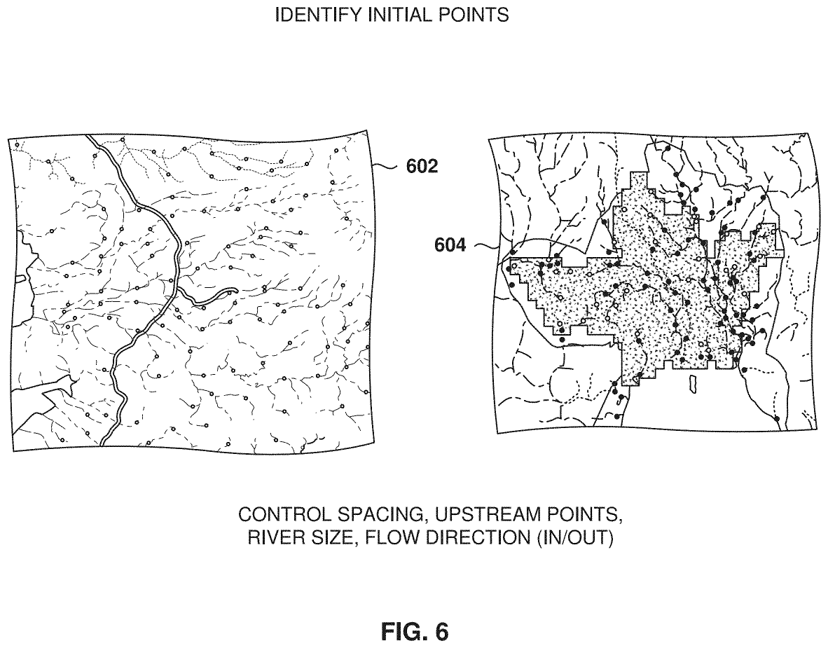

FIG. 6 shows the initial selection of points for determining the riverine information, according to some example embodiments. Map 602 shows the initial source points overlaying the high-resolution raster. The initial definition is configurable based on spacing, size of the river to include in the initial points, and the flow direction (in or out of the cell). Further, Map 604 shows upstream points identified within an urban area.

In some example embodiments, the points in the rivers are defined by a DEM based on the topography, and the program automatically places points with the lower elevations along those rivers. The program has some configurable parameters, like the spacing between points. By adjusting the distancing to be smaller or bigger, the user can control the size of rivers to be considered for the initial points (e.g., for identifying only large rivers, greater spacing is used resulting in fewer points).

FIG. 7 illustrates the operation for fine-tuning the points associated with the river channels, according to some example embodiments. Map 702 is an example of a representation of an output from running the synthetic model, where darker areas correspond to points with higher water depths. Map 704 shows that the final source point locations are snapped to inundation model cells of the greatest depth within a neighborhood.

During the fine-tuning operation, the initial river points from the synthetic simulation (as shown in map 702) are analyzed to ensure that they are within the river channel. The synthetic simulation models dumping rainfall on the area and the results shows how the model identifies the channels that carry the water.

The initial points are checked by doing a neighborhood search around each one of the initial points and the deepest cell is determined. Then the deepest cell with the deepest water level is snapped to that point. That is, the channel is considered to be where the model predicts the largest depth in the river. The process is performed for all of the river channels in the region.

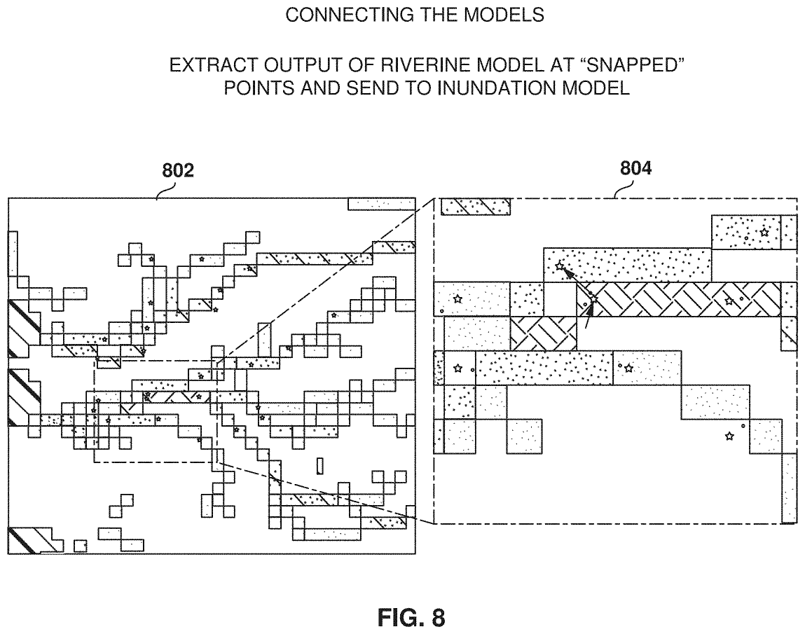

FIG. 8 illustrates how to use the output of the riverine model as input for the inundation model, according to some example embodiments. The output of the riverine model (illustrated at map 802) at each of the initial points is sent to the inundation model.

In some example embodiments, the resolution of the riverine model and the inundation model are different and that is why a translation has to be performed. An automated process takes the initial points and then “snaps” them to the river channel, as illustrated in map 804.

For example, the resolution of the riverine model is one kilometer and the resolution for the inundation model is 30 meters. The process then takes the initial points within the large one-kilometer cells and places them precisely on the high-resolution 30 m cells. The placement is not just based on proximity, but also uses the information from the synthetic model identifying the river channels. That is, the program uses the drainage area, which is an indication of the size of the river. The program aims at making sure that it identifies cells in the right river by looking at the drainage area of the synthetic models.

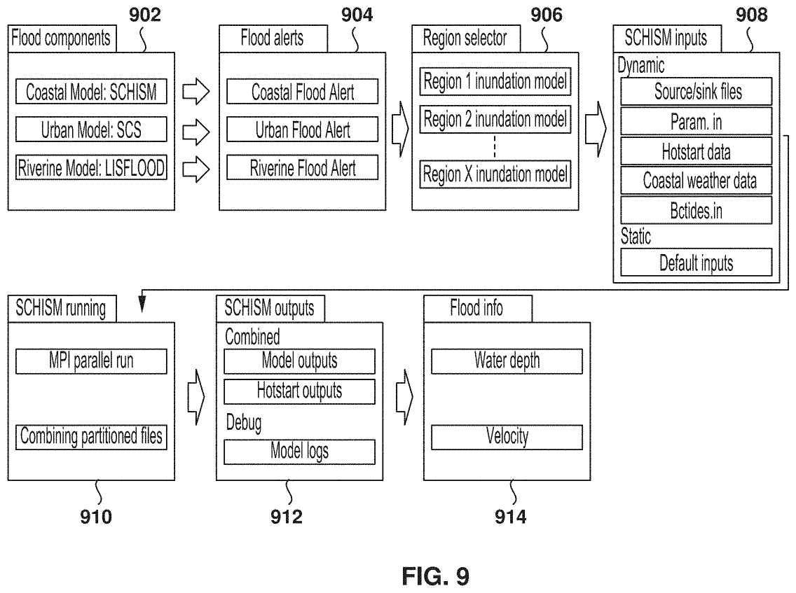

FIG. 9 shows a high-level flow of operations for estimating the flood information, according to some example embodiments. At a high level, the flood models 902 include the coastal, urban, and riverine models.

The flood models 902 may generate alerts 904 (e.g., coastal flood alert, urban flood alert, and riverine flood alert). When any alert is triggered, the region selector 906 determines which region or regions will be included in the analysis for the flood information.

After the regions are selected, the inputs 908 for the inundation model (e.g., SCHISM inputs) are selected. In some example embodiments, the SCHISM inputs include the source and sink points, configuration parameters file, hotstart data to initialize the model, coastal weather data, betides information, and other static default inputs.

At operation 910, the inundation model is run, which results in the simulation outputs 912, which include model outputs, hotstart outputs, and model logs for debugging. The simulation outputs 912 are then converted into flood information 914, which includes, at least, the water depth and water velocity at each cell.

In some example environments, the coastal model is a SCHISM model, which is a cross-scale model covering deep ocean and shallow coastal areas. SCHISM uses weather forecasts to predict coastal water level and the prediction is used for coastal alerts.

In some example embodiments, the urban model is an SCS model, although other models may be used. SCS uses weather forecasts to calculate urban rainfall runoff (volume sources) and infiltration rates (sinks), and then passes runoff and infiltration fields to the SCHISM inundation model.

In some example embodiments, the riverine model is LISFLOOD, which uses weather forecasts to calculate river flow at specific locations and then passes time series of sources to the SCHISM inundation model.

The flood models 902 can be run continuously, periodically, or on demand to search for flood conditions that would generate an alert. In some example embodiments, each region has predefined flood levels for triggering the alerts. If a flood level is reached for any region or city, then the inundation model is executed.

The inundation model inputs include dynamic inputs that change for each simulation and static inputs that do not change for each simulation. In some example embodiments, the dynamic inputs include source and sink points, model parameters, a hotstart file, coastal weather data, and betides.

For the source and sink points, urban and riverine model outputs are converted into SCHISM defined format in ASCII files. These source and sink points determine the water volume inputs in the model.

The model parameters define the inundation model. The following are some examples of model parameters:
Model time:
   start_year=$START_YEAR !YYYY
   start_month=$START_MONTH !1-12
   start_day=$START_DAY !1-31
   start_hour=$START_HOUR !double
   mday=$RNDAY ! duration in days
If coldstart or hotstart:
   ihot=$IHOT ! 0 if cold; 1 if hot.
   nramp=$NRAMP ! 1 if cold; 0 if hot.
   dramp=$DRAMP ! 3 if cold; 0 if hot.
   nramp_ss=$NRAMP_SS ! 1 if cold; 0 if hot.
   dramp_ss=$DRAMP_SS ! 5 if cold; 0.001 if hot.
   nrampwind=$NRAMPWIND ! 1 if cold; 0 if hot.
   drampwind=$DRAMPWIND ! 1 if cold; 0 if hot.
Coastal, riverine, or urban (Note: coastal flood is always turned on in SCHISM.)
if_source=$IF_SOURCE ! 0 if only coastal is on; 1 if either riverine or urban or both is on

The hotstart file is a NETCDF file with the initial conditions to run the inundation model so the inundation model does not have to start from an unknown state. The hotstart file is generated by previous SCHISM runs. Each SCHISM run generates a hotstart file for each output interval (e.g., 1 hour). Further, the betides.in is an ASCII file with coastal boundary information related to astronomical tide parameters.

The static inputs are associated with each inundation grid and do not change with different runs using the same inundation grid. The static inputs include mesh files, a bottom friction parameter file, an initial elevation file, and a vertical grid file.

Regarding the flood information 914, the water depth and velocity predictions can be extracted from the SCHISM outputs at all mesh nodes, e.g., XYZ, XYU, and XYV (depth Z, velocity U, and V). With this information, it is possible to show a flood depth map and/or a velocity map over an entire city or a large region.

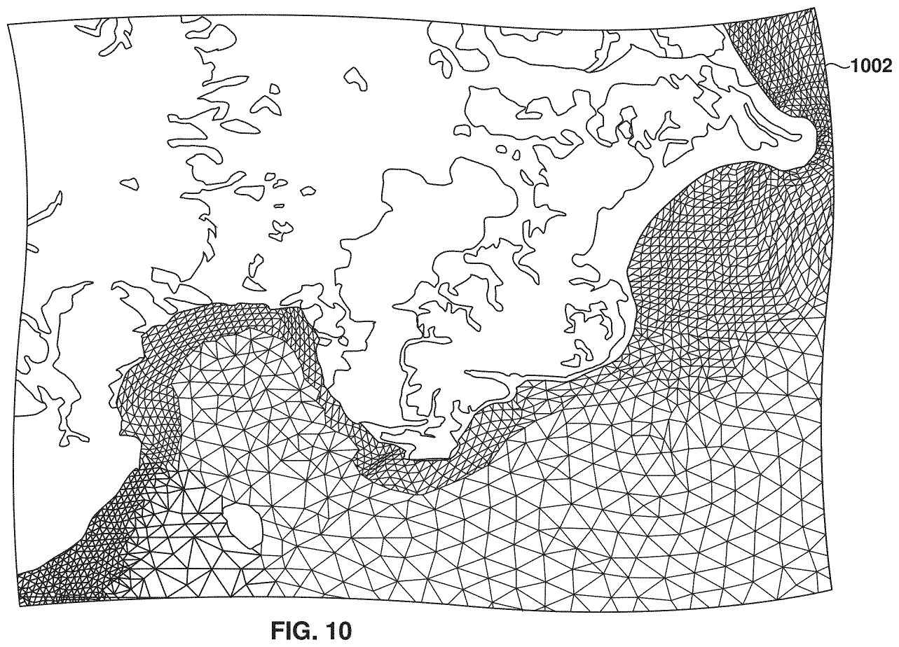

FIG. 10 is a map 1002 illustrating a maritime mesh for the coastal model, according to some example embodiments. The mesh in the coast has a higher resolution, which gradually decreases for cells further from coast.

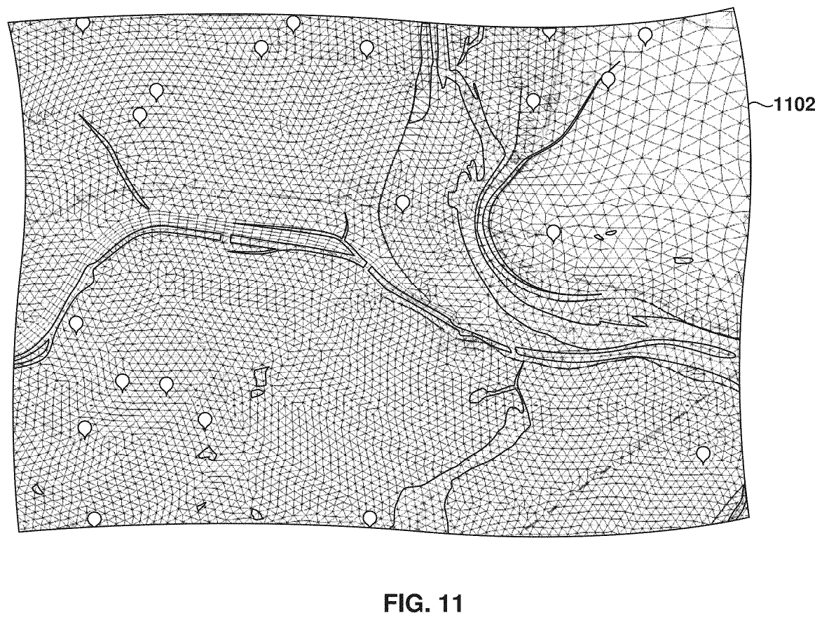

FIG. 11 is an example of a model mesh with a transition from high to low resolution, according to some example embodiments. In map 1102, it can be observed how the mesh on the right, corresponding to a rural area, has a lower resolution than the mesh on the rest of the map 1102, which corresponds to a city area. The map 1102 also includes some river channels.

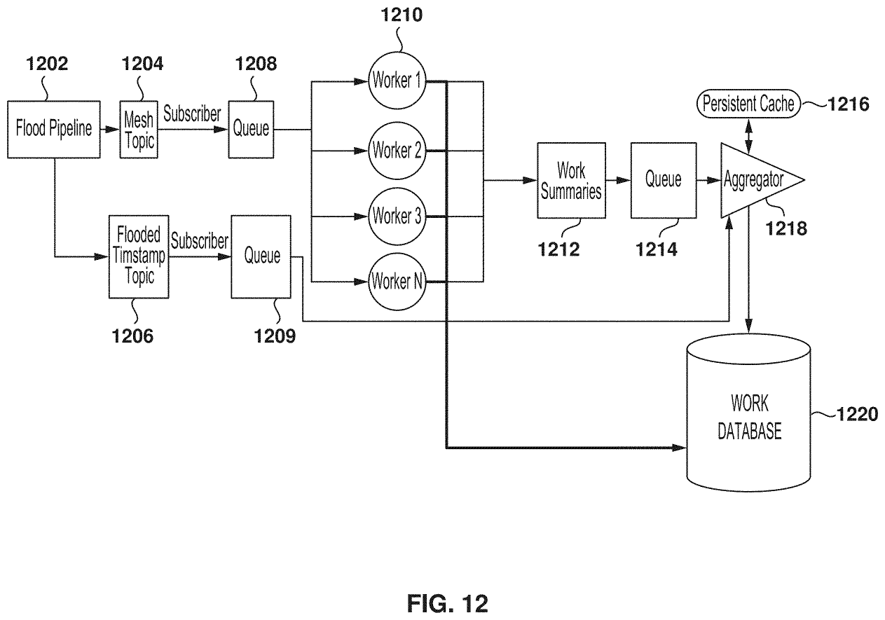

FIG. 12 is a sample architecture for calculating flood parameters by the inundation model, according to some example embodiments. A flood pipeline 1202 is the information coming from the coastal, riverine, and urban models, and messages from the flood pipeline 1202 are published to a topic. The topics can be a mesh topic 1204 for the flood depth predictions and a flooded-timestamp topic 1206, which includes metadata about the predictions from the models. This information is sent directly to an aggregator 1218, which is a program executing on one or more processors. For example, this metadata may be used to set the start time and the end time of the prediction.

Each topic has a respective queue: a mesh-topic queue 1208 or a flooded-timestamp topic queue 1209. The flood prediction data is broken into multiple messages to parallelize the work for workers 1210. The workers 1210 subscribe to a topic and dequeue messages from the corresponding queue. When the worker 1210 retrieves a message from the queue, the worker 1210 processes the message, writes the results to a work database 1220, and then sends an acknowledgment that the message has been received. The worker 1210 does not acknowledge the message until the message has been processed and the results stored in the work database 1220, ensuring that the data being processed is not lost if there is a worker problem.

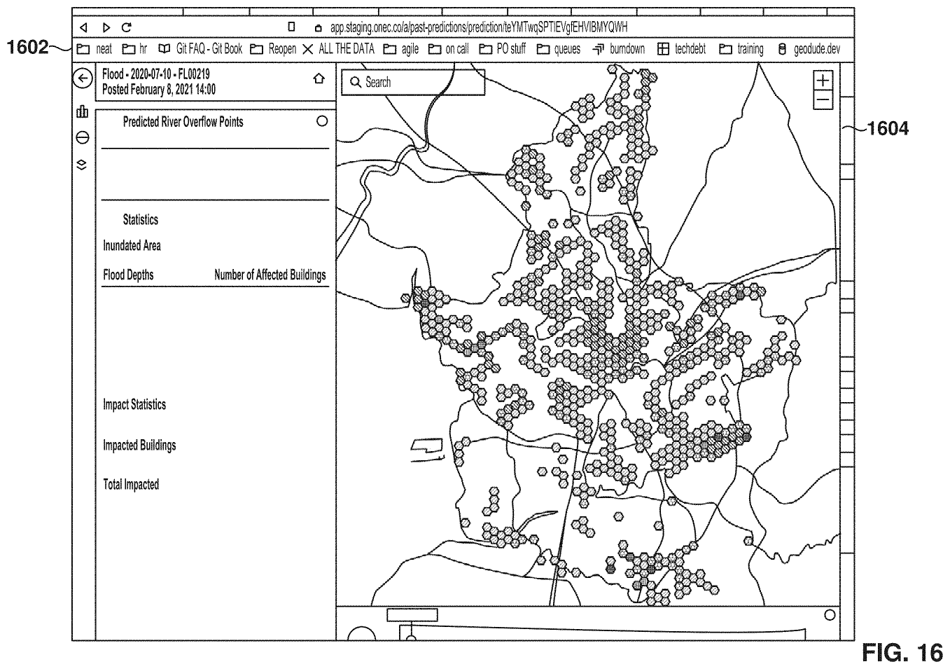

The workers 1210 process messages in any order, and they do the sort of binning operation to collect flood points and associate them with the correct map cells (e.g., hexagons as shown in the example of FIG. 16). In some example embodiments, the workers 1210 are virtual machines instantiated on a cloud service, but other worker pool configurations are possible.

Each time one worker 1210 finishes processing the message, the worker 1210 publishes a work summary 1212, which is placed on a queue 1214 to be processed by the aggregator 1218. The work summary 1212 includes flood information regarding maximum depth, inundation area, and other flight data. This information is used to calculate event level statistics for the area under consideration.

The aggregator 1218 collects the work summaries 1212 and calculates the predicted flood values. In some example embodiments, the results from the aggregator are flood depth and water velocity for the cells of the mesh in the region. The aggregator 1218 saves the results in the work database 1220. Further, the aggregator utilizes a persistent cache 1216 that ensures that data is not lost if the aggregator 1218 crashes.

In some example environments, the final results from the aggregator 1218 include flood values for the cells, including average depth inside the cell, the impacted buildings in the cell, and the people impacted.

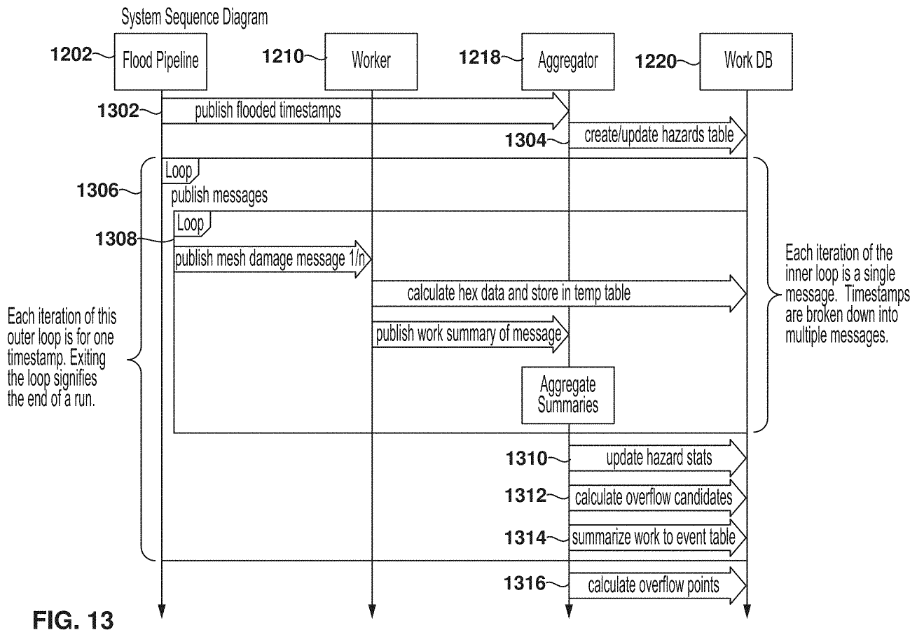

FIG. 13 is a sample sequence diagram for calculating flood parameters, according to some example embodiments. The flood pipeline publishes 1302 the flooded timestamps to the aggregator 1218, and the aggregator 1218 creates or updates 1304 the hazard table that is stored in the work database 1220.

Each iteration of loop 1306 is for one timestamp, and the loop 1306 ends when all the timestamps have been processed. The loop 1306 includes loop 1308, and each iteration in the 1306 is to process a single message, where timestamps are broken into multiple messages.

The loop 1308 includes publishing the mesh damage message from the flood pipeline 1202 to the worker 1210. The worker 1210 then calculates cell data and stores the results in the work database 1220. Further, the worker 1210 publishes the work summary to the aggregator 1218. The aggregator then aggregates the summaries from all the workers.

After loop 1308 ends but still within the loop 1306, the aggregator 1218 updates 1310 the work database 1220 with hazard statistics, overflow candidates 1312, and summary work in an event table 1314. Further, after loop 1306 ends, the aggregator 1218 updates 1316 the work database 1220 with the overflow points.

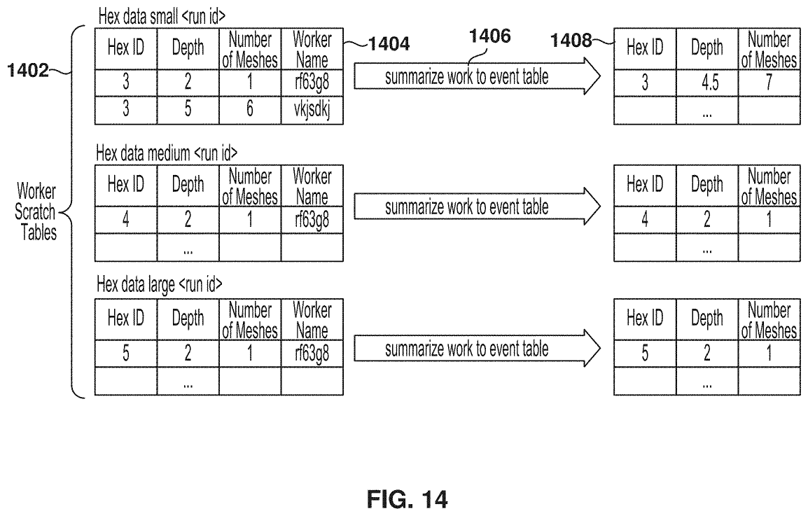

FIG. 14 illustrates how the data from multiple workers is combined, according to some example embodiments. The data for the workers is split so there is no overlap of processing by the workers, but the output of the workers may overlap because it refers to the same cell. To overcome this problem, the aggregator consolidates the data when there are overlaps.

The work database includes several worker scratch tables 1402. Each worker writes to one scratch table, and a new set of worker scratch tables 1402 are created for each iteration.

When the aggregator receives the work summaries for a given timestamp, the aggregator issues a query to the database to the worker scratch tables 1402 and places the results in a corresponding event table 1408.

Each worker scratch table 1402 includes the cell identifier, referred to as Hex ID, the depth in the cell, the number of meshes, and the worker name. When data from multiple workers overlap, there are several entries in the scratch table for the same ID. The aggregator summarizes 1406 the results for the given hex ID to obtain the event tables 1408. If one of the worker scratch tables 1402 includes entries from multiple workers (e.g., table 1404), the aggregator consolidates the data from the multiple workers into a single value for the hex ID.

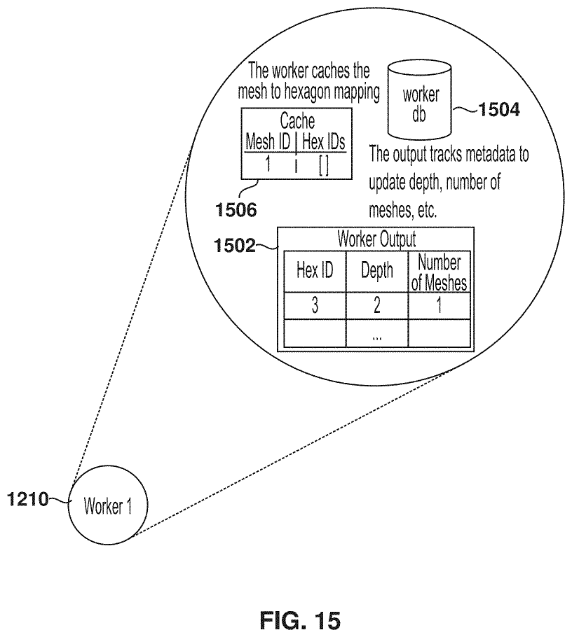

FIG. 15 shows components of a worker 1210, according to some simple embodiments. The worker 1210 is responsible for calculating the values for the scratch tables. In some example embodiments, the worker 1210 includes a worker cache 1506 and a worker database 1504. Further, the worker 1210 generates the worker output 1502.

The design allows for each worker 1210 to work independently from other workers. For example, the incoming data may include information for 45 million points. The information from the points are divided into groups of points, and then each group is processed independently by a worker.

The worker output 1502 tracks some metadata to update the water depth and the number of meshes being acted upon. The worker output 1502 is a table with columns for hex ID, water depth, and the number of meshes. In some example embodiments, the worker 1210 also calculates the damage to buildings in the cell.

FIG. 16 is a UI 1602 for showing flooding in a region, according to some example embodiments. In this sample environment, a map 1604 is provided within the UI, and the map is divided into hexagons showing color-mapped flood levels or, when the map is shown for an estimated future time, predicted flood levels. Each of the hexagons are associated with a hex ID, as described above with reference to FIGS. 12-15.

On the left side of the UI 1602, additional information is presented regarding the flood levels, such as flood depths and the number of buildings affected for each category of flood depth. Further, additional statistical values may be provided regarding the impacted buildings and the people affected by the flood.

In some example embodiments, the UI 1602 sends a request to the flood management system via an API, providing the coordinates for two corners of the map. The flood management system then replies with the hexagon IDs and water depth for each hexagon in the map, within the given coordinates. This way, a simple API call returns a small amount of data, enough to display the whole map 1604 with the water depth. Other solutions require sending the coordinates of each hexagon, which requires a much larger amount of data to be transmitted to display the map 1604.

In some example embodiments, there will hexagon resolutions for displaying the map 1604. Based on the macro solution, a resolution for the hexagons is selected, such that the number of hexagons in the map provide a good resolution, but not too fine a resolution that does not add value to the map while requiring more work and more network traffic. For example, one system includes hexagon resolutions of 30 m, 250 m, and 500 m, but other systems may use different resolutions, and a larger number of resolutions.

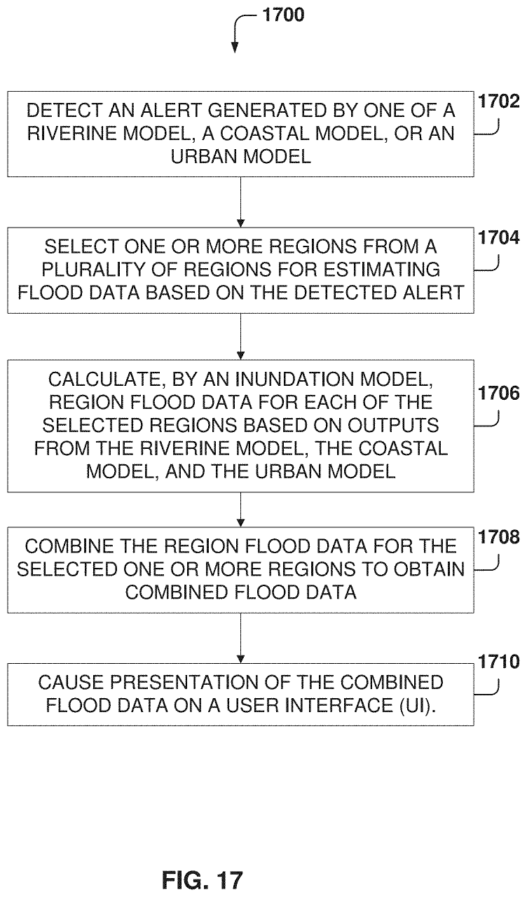

FIG. 17 is a flowchart of a method 1700 for determining flood levels within a region, according to some example embodiments. While the various operations in this flowchart are presented and described sequentially, one of ordinary skill will appreciate that some or all of the operations may be executed in a different order, be combined or omitted, or be executed in parallel.

Operation 1702 is for detecting an alert generated by one of a riverine model, a coastal model, or an urban model.

From operation 1702, the method 1700 flows to operation 1704 for selecting one or more regions from a plurality of regions for estimating flood data based on the detected alert.

From operation 1704, method 1700 flows operation 1706 to calculate, by an inundation model, region flood data for each of the selected regions based on outputs from the riverine model, the coastal model, and the urban model.

From operation 1706, the method 1700 flows operation 1708 for combining the region flood data for the selected one or more regions to obtain combined flood data.

From operation 1708, the method 1700 flows to operation 1710 for causing presentation of the combined flood data on a UI.

In one example, the riverine model is configured to generate the alert, the coastal model is configured to generate the alert, and the urban model is configured to generate the alert.

In one example, the method 1700 further comprises, before calculating the region flood data, formatting outputs from the riverine model, the coastal model, and the urban model to a format ready for the inundation model.

In one example, the method 1700 further comprises calculating, by the inundation model, structural impact to buildings caused by flooding.

In one example, the riverine model, the coastal model, and the urban model use inputs of natural environment data, built environment data, and weather data.

In one example, the method 1700 further comprises running a simulation with synthetic data to identify source and sink points in the region, the synthetic data comprising uniform rainfall in the region.

In one example, the method 1700 further comprises fine-tuning the identified source and sink points in the region by running a simulation of the inundation model.

In one example, the combined flood data includes a time series of water depth and velocity for an estimated period of time.

In one example, the inundation model is executed by a plurality of workers executing in parallel, with each worker calculating flood data for a cell in the region.

In one example, the coastal model uses weather forecasts to predict coastal water levels, the riverine model predicts the water level of rivers, and the urban model predicts water levels in urban areas using rainfall runoff and infiltration rates.

Another general aspect is for a system that includes a memory comprising instructions and one or more computer processors. The instructions, when executed by the one or more computer processors, cause the one or more computer processors to perform operations comprising: detecting an alert generated by one of a riverine model, a coastal model, or an urban model; selecting one or more regions from a plurality of regions for estimating flood data based on the detected alert; calculating, by an inundation model, region flood data for each of the selected regions based on outputs from the riverine model, the coastal model, and the urban model; combining the region flood data for the selected one or more regions to obtain combined flood data and causing presentation of the combined flood data on a UI.

In yet another general aspect, a machine-readable storage medium (e.g., a non-transitory storage medium) includes instructions that, when executed by a machine, cause the machine to perform operations comprising: detecting an alert generated by one of a riverine model, a coastal model, or an urban model; selecting one or more regions from a plurality of regions for estimating flood data based on the detected alert; calculating, by an inundation model, region flood data for each of the selected regions based on outputs from the riverine model, the coastal model, and the urban model; combining the region flood data for the selected one or more regions to obtain combined flood data; and causing presentation of the combined flood data on a UI.

In view of the disclosure above, various examples are set forth below. It should be noted that one or more features of an example, taken in isolation or combination, should be considered within the disclosure of this application.

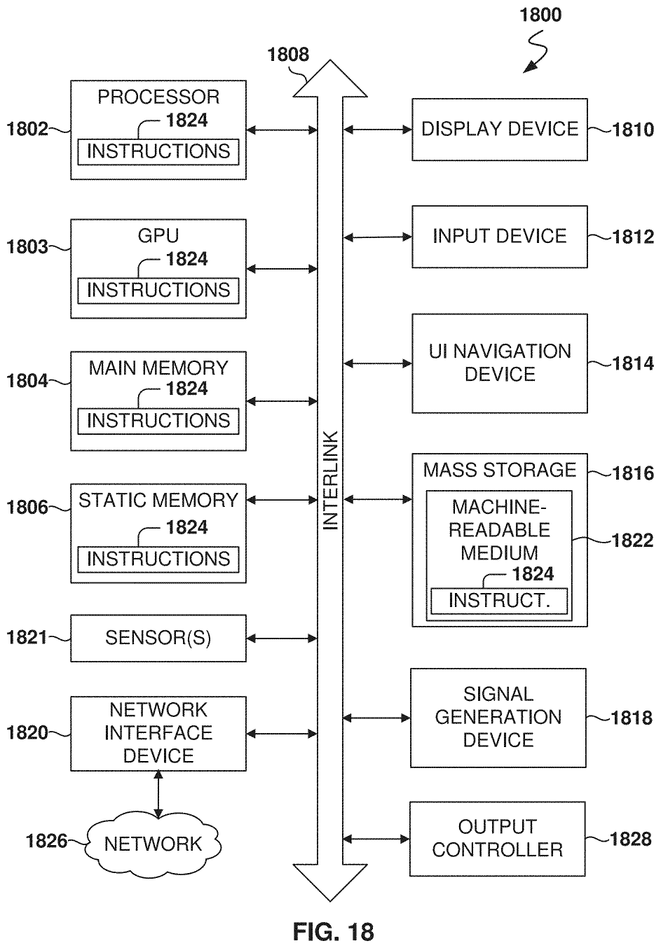

FIG. 18 is a block diagram illustrating an example of a machine 1800 upon or by which one or more example process embodiments described herein may be implemented or controlled. In alternative embodiments, the machine 1800 may operate as a standalone device or may be connected (e.g., networked) to other machines. In a networked deployment, the machine 1800 may operate in the capacity of a server machine, a client machine, or both in server-client network environments. In an example, the machine 1800 may act as a peer machine in a peer-to-peer (P2P) (or other distributed) network environment. Further, while only a single machine 1800 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, a number of components, or mechanisms. Circuitry is a collection of circuits implemented in tangible entities that include hardware (e.g., simple circuits, gates, logic). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits) including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1800 may include a hardware processor 1802 (e.g., a central processing unit (CPU), a hardware processor core, or any combination thereof), a graphics processing unit (GPU) 1803, a main memory 1804, and a static memory 1806, some or all of which may communicate with each other via an interlink 1808 (e.g., bus). The machine 1800 may further include a display device 1810, an alphanumeric input device 1812 (e.g., a keyboard), and a UI navigation device 1814 (e.g., a mouse). In an example, the display device 1810, alphanumeric input device 1812, and UI navigation device 1814 may be a touch screen display. The machine 1800 may additionally include a mass storage device (e.g., drive unit) 1816, a signal generation device 1818 (e.g., a speaker), a network interface device 1820, and one or more sensors 1821, such as a Global Positioning System (GPS) sensor, compass, accelerometer, or another sensor. The machine 1800 may include an output controller 1828, such as a serial (e.g., universal serial bus (USB)), parallel, or other wired or wireless (e.g., infrared (IR), near field communication (NFC)) connection to communicate with or control one or more peripheral devices (e.g., a printer, card reader).

The mass storage device 1816 may include a machine-readable medium 1822 on which is stored one or more sets of data structures or instructions 1824 (e.g., software) embodying or utilized by any one or more of the techniques or functions described herein. The instructions 1824 may also reside, completely or at least partially, within the main memory 1804, within the static memory 1806, within the hardware processor 1802, or within the GPU 1803 during execution thereof by the machine 1800. In an example, one or any combination of the hardware processor 1802, the GPU 1803, the main memory 1804, the static memory 1806, or the mass storage device 1816 may constitute machine-readable media.

While the machine-readable medium 1822 is illustrated as a single medium, the term “machine-readable medium” may include a single medium, or multiple media, (e.g., a centralized or distributed database, and/or associated caches and servers) configured to store the one or more instructions 1824.

The term “machine-readable medium” may include any medium that is capable of storing, encoding, or carrying instructions 1824 for execution by the machine 1800 and that cause the machine 1800 to perform any one or more of the techniques of the present disclosure, or that is capable of storing, encoding, or carrying data structures used by or associated with such instructions 1824. Non-limiting machine-readable medium examples may include solid-state memories, and optical and magnetic media. In an example, a massed machine-readable medium comprises a machine-readable medium 1822 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1824 may further be transmitted or received over a communications network 1826 using a transmission medium via the network interface device 1820.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
detecting, by one or more processors, an alert generated by one of a riverine model, a coastal model, or an urban model;
selecting, by the one or more processors, one or more regions from a plurality of regions for estimating flood data based on the detected alert;
calculating, by an inundation model using the one or more processors, region flood data for each of the selected regions based on outputs from the riverine model, the coastal model, and the urban model;
combining, by the one or more processors, the region flood data for the selected one or more regions to obtain combined flood data; and causing presentation of the combined flood data on a user interface (UI).

2. The method as recited in claim 1, wherein the riverine model is configured to generate the alert, wherein the coastal model is configured to generate the alert, wherein the urban model is configured to generate the alert.

3. The method as recited in claim 1, further comprising:
before calculating the region flood data, formatting outputs from the riverine model, the coastal model, and the urban model to a format ready for the inundation model.

4. The method as recited in claim 1, further comprising:
calculating, by the inundation model, structural impact to buildings caused by flooding.

5. The method as recited in claim 1, wherein the riverine model, the coastal model, and the urban model use inputs of natural environment data, built environment data, and weather data.

6. The method as recited in claim 1, further comprising:
running a simulation with synthetic data to identify source and sink points in the region, the synthetic data comprising uniform rainfall in the region.

7. The method as recited in claim 6, further comprising:
fine-tuning the identified source and sink points in the region by running a simulation of the inundation model.

8. The method as recited in claim 1, wherein the combined flood data includes a time series of water depth and velocity for an estimated period of time.

9. The method as recited in claim 1, wherein the inundation model is executed by a plurality of workers executing in parallel, each worker calculating flood data for a cell in the region.

10. The method as recited in claim 1, wherein the coastal model uses weather forecasts to predict coastal water levels, the riverine model predicts water level of rivers, and the urban model predicts water levels on urban areas using rainfall runoff and infiltration rates.

11. A system comprising:
a memory comprising instructions; and
one or more computer processors, wherein the instructions, when executed by the one or more computer processors, cause the system to perform operations comprising:
detecting an alert generated by one of a riverine model, a coastal model, or an urban model;
selecting one or more regions from a plurality of regions for estimating flood data based on the detected alert;
calculating, by an inundation model, region flood data for each of the selected regions based on outputs from the riverine model, the coastal model, and the urban model;
combining the region flood data for the selected one or more regions to obtain combined flood data; and
causing presentation of the combined flood data on a user interface (UI).

12. The system as recited in claim 11, wherein the riverine model is configured to generate the alert, wherein the coastal model is configured to generate the alert, wherein the urban model is configured to generate the alert.

13. The system as recited in claim 11, wherein the instructions further cause the one or more computer processors to perform operations comprising:
before calculating the region flood data, formatting outputs from the riverine model, the coastal model, and the urban model to a format ready for the inundation model.

14. The system as recited in claim 11, wherein the instructions further cause the one or more computer processors to perform operations comprising:
calculating, by the inundation model, structural impact to buildings caused by flooding.

15. The system as recited in claim 11, wherein the riverine model, the coastal model, and the urban model use inputs of natural environment data, built environment data, and weather data.

16. A tangible machine-readable storage medium including instructions that, when executed by a machine, cause the machine to perform operations comprising:
detecting an alert generated by one of a riverine model, a coastal model, or an urban model;
selecting one or more regions from a plurality of regions for estimating flood data based on the detected alert;
calculating, by an inundation model, region flood data for each of the selected regions based on outputs from the riverine model, the coastal model, and the urban model;
combining the region flood data for the selected one or more regions to obtain combined flood data; and
causing presentation of the combined flood data on a user interface (UI).

17. The tangible machine-readable storage medium as recited in claim 16, wherein the riverine model is configured to generate the alert, wherein the coastal model is configured to generate the alert, wherein the urban model is configured to generate the alert.

18. The tangible machine-readable storage medium as recited in claim 16, wherein the machine further performs operations comprising:
before calculating the region flood data, formatting outputs from the riverine model, the coastal model, and the urban model to a format ready for the inundation model.

19. The tangible machine-readable storage medium as recited in claim 16, wherein the machine further performs operations comprising:
calculating, by the inundation model, structural impact to buildings caused by flooding.

20. The tangible machine-readable storage medium as recited in claim 16, wherein the riverine model, the coastal model, and the urban model use inputs of natural environment data, built environment data, and weather data.
